(19) United States
(12) Patent Application Publication
(10) Pub. No.: US 2015/0289087 A1
(43) Pub. Date: Oct. 8, 2015

(54) PASSENGER AND BAGGAGE SECURE ACCESS MANAGEMENT AND TRACKING SYSTEM

(71) Applicant: Hafeez OKI, Ottawa (CA)

(72) Inventor: Hafeez OKI, Ottawa (CA)

(73) Assignee: Hafeez OKI, Ottawa, ON (CA)

(21) Appl. No.: 14/244,528

(22) Filed: Apr. 3, 2014

(51) Int. Cl. H04W 4/02; H04B 1/3816; H04W 12/06; B64F 1/36; G06Q 10/02

(52) U.S. Cl. CPC H04W 4/02; B64F 1/368; G06Q 10/025; H04W 12/06; H04B 1/3816

(57) ABSTRACT

A multifunction device for tracking passengers has a case, a battery within the case, a bodily attachment means mounted to the case for attaching the case to the body of a passenger, a screen on the case for displaying information to the passenger, a GPS receiver mounted within the case, for receiving position data, and a wireless transmitter mounted within the case, for transmitting data wirelessly, wherein the device tracks the location of the wearer through the GPS receiver and directs the passenger within a travel infrastructure through information on the screen. A multifunction device for tracking luggage has a case, a battery within the case for powering the device, a luggage attachment means mounted to the case for attaching the case to the luggage, and identification means. In an embodiment, the identification means is selected from the group consisting of a barcode, an RFID signal and a wireless signal.

### FIELD OF THE INVENTION

The invention relates to passenger and baggage secure access and tracking systems.

### BACKGROUND OF THE INVENTION

Particularly since the terrorist attacks of Sep. 11, 2001, airport and traveler security has been under scrutiny. Airports often hire security companies, which have staff patrolling the area, as well as surveillance of the airport. These security companies are expensive and cumbersome, and have trouble identifying particular individuals or baggage that they find. While identification of passengers and baggage is the goal of the security companies, the technology employed by security companies to identify passengers and baggage is outdated. Often security companies are reacting to events rather than proactively acting to prevent the events from occurring in the first place.

Passengers identify themselves through the airport with boarding passes. Boarding passes are awkward to hold along with all the other baggage that a passenger is carrying, yet the passes are required to be held while passing through security. Further, boarding passes are merely pieces of paper which may be transferred from one passenger to another with forged identification, for example.

Baggage is separated from passengers when placed underneath the plane. If the plane is loaded and ready for takeoff, yet a passenger fails to appear, then the luggage belonging to that passenger must be found and removed from the plane. This is a time-consuming process which inconveniences the other passengers and delays flights. Further, each baggage tag must be read to identify the baggage to be removed. It would be advantageous if the baggage was able to call attention to itself so as to be dealt with expediently.

Furthermore, when the baggage arrives at its final destination, it may be picked up by another passenger, mistaken for his or her own bag. In such cases of mistaken identity, baggage often never returned to its rightful owner. Baggage which is unclaimed as a result of being lost or misdirected ends up in an Unclaimed Baggage Center such as that in Scottsboro Ala., where the baggage is eventually resold. There is a need to tracking baggage to avoid lost and unclaimed baggage.

Therefore there is a need for a passenger and baggage tracking system for airports and other traveler facilities such as hotels.

### SUMMARY OF THE INVENTION

A multifunction device for tracking passengers, has a case, a battery within the case for powering the device, a bodily attachment means mounted to the case for attaching the case to the body of a passenger, a screen on the case for displaying information to the passenger, a GPS receiver mounted within the case, for receiving position data, and a wireless transmitter mounted within the case, for transmitting data wirelessly, wherein the device tracks the location of the wearer through the GPS receiver and directs the passenger within a travel infrastructure through information on the screen, such that the passenger is able to efficiently move through the travel infrastructure.

The multifunction device may transmit the location of the passenger to a security system through the wireless transmitter. In an embodiment, the wireless transmitter transmits authorization information to enable the passenger to access areas of the travel infrastructure. In an embodiment, the wireless transmitter transmits authorization information to enable the passenger to receive luggage. In another embodiment, the screen displays a barcode for a boarding pass for scanning by airline staff. The device may also have a SIM for communicating on a cell network.

The device may be locked to the passenger and the device is keyed to government-issued photo identification of the passenger. Further, the wireless transmitter may be in communication with nearby devices to determine the identities of other device users in near proximity with the passenger.

A multifunction device for tracking luggage, has a case, a battery within the case for powering the device, a luggage attachment means mounted to the case for attaching the case to the luggage, and identification means. In an embodiment, the identification means is selected from the group consisting of a barcode, an RFID signal and a wireless signal. The device may also have a wireless transmitter mounted within the case, for transmitting identify data of the luggage wirelessly. In a further embodiment, the device also has a GPS receiver, wherein the multifunction device transmits location data of the luggage to a security system through the wireless transmitter.

A method of use for a multifunction device for tracking passengers has the steps of e-booking the travel arrangements, downloading e-tickets to the multifunction device, generating an ISOIEC standard barcode for the itinerary and storing the barcode within the device, and displaying the barcode at a gate in order to board an airplane. The method may also have the step of displaying airport safety and security information on the device. The method may also have the step of displaying in-flight safety and security information on the device, and may also have the step of displaying law enforcement agency safety and security information on the device. In a further embodiment, the method has the step of displaying government department of foreign affairs department safety and security information on the device.

### BRIEF DESCRIPTION OF THE FIGURES

FIG. 1 is a plan view of the multifunction device.

FIG. 2 is an exploded view of the multifunction device.

FIG. 3 is a flowchart for a method of use.

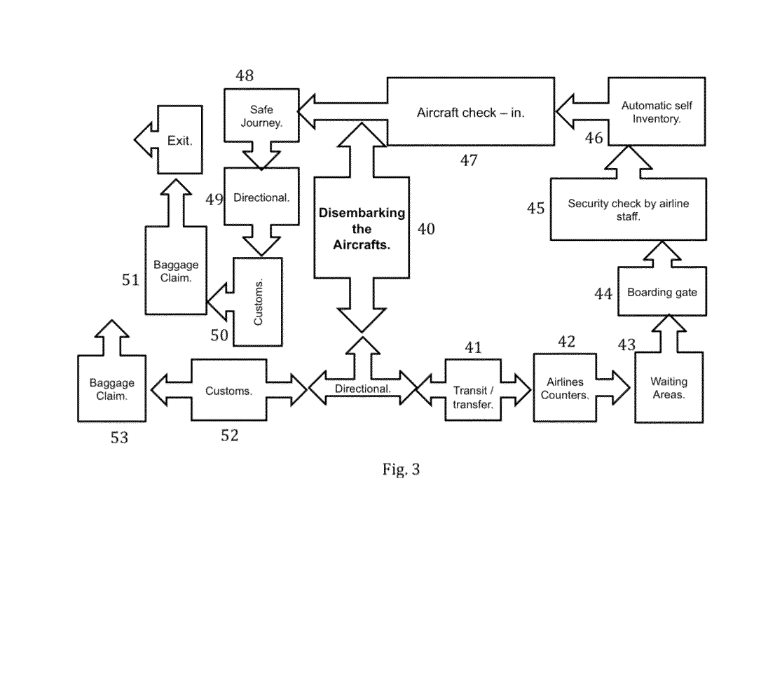

FIG. 4 is a plan view of the multifunction device for baggage.

FIG. 5 is a flowchart showing a method of use in regards to travel.

FIG. 6 is a flowchart showing a method of use in regards to hotels.

### DETAILED DESCRIPTION OF THE INVENTION

Smart secure access is designed for secure access management and to tracking persons of interest and collecting valuable data for the use of the transportation, corporate business, law enforcement and intelligence communities to enable them to strengthen the security of the world's transportation and tourism system to ensure freedom of movement for people and commerce. Smart secure access is part of an access management system, and uses a combination of GPS, WiFi and cell tower data to locate the person(s). It assists with access management, inventory management, personal identification, communications such as email and SMS, secure communication, personal tracking and monitoring, and baggage tracking logistics.

The passenger and baggage secure access and tracking system works to track users of transportation facilities, such as airports, and their baggage. The system is implemented uniformly in all airports and other travel facilities throughout the world, in order to maintain consistency. A global database is also part of the system, which is used to identify persons of interest who use the system. In the system, any user wishing to travel must use the multifunction device, which is removably affixed around the wrist of the user, for example, or causes an alarm to sound if removed. The traveler wears the device, which contains his or her personal data, during travel. The device communicates with a database wirelessly, and provides the user with travel convenience, and the authorities with passenger tracking.

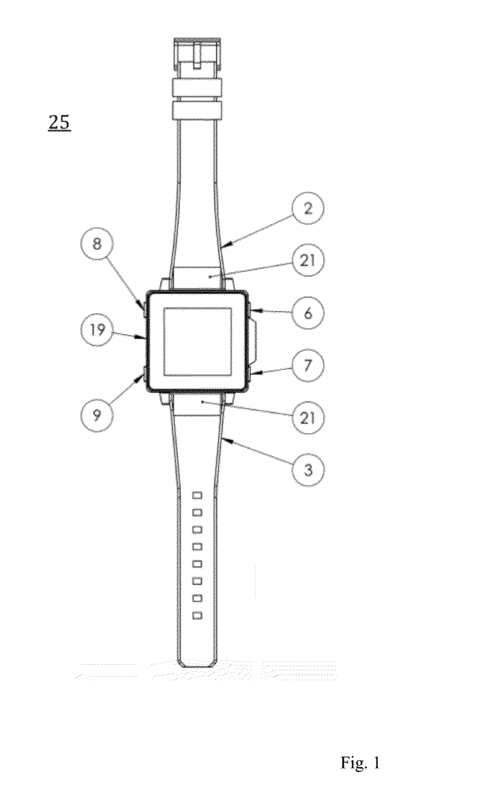

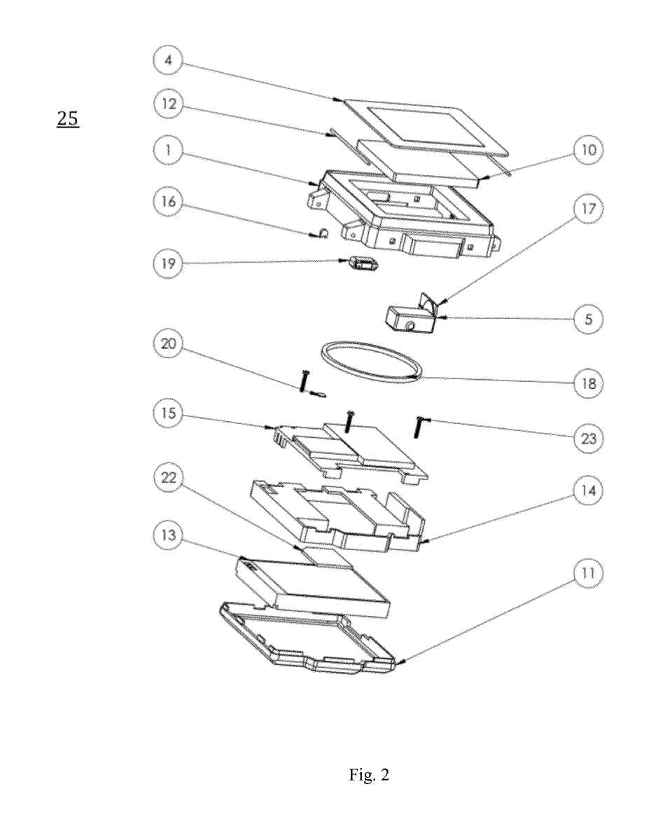

With reference to FIGS. 1 and 2, the multifunction device 25 is shown in a plan view and an exploded view, respectively. A case 1 holds the electronic components of the multifunction device and protects them from the environment. The case may be any shape that is practical for holding the components; however a square case is preferred. Wrist straps 2 and 3 extend from either side of the case, in a pivotal relation with the case, and are adapted for closing around the wrist of a wearer. An embodiment for mounting on luggage may not have wrist straps, rather means for firm attachment to luggage. They are held to the case by strap pins 12. The glass 4 closes the top of the case and allows the user to see the display 10 through the glass 4, and may be a touchscreen that enables the user to communicate with the device by touching the screen.

The back of the case 1 is closed by a back panel 11. The display 10 shows the user the information from the multifunction device whether in alphanumeric format or as graphics or a combination of the two. Pushers 6 and 7 are buttons that enable further communication with the device. In one embodiment, pusher 8 is an on/off switch for the display or device to “awaken” the device after the display turns off for battery conservation. In an embodiment, SOS pusher 9 causes an emergency signal to be transmitted from the device, to signal an emergency situation for the user or another close by.

To provide power, a battery 13 is contained within the case 1. In one embodiment, the battery 13 is a rechargeable lithium ion cell of approximately 400 mAh capacity. Within the case there may be one or more supports 14 to prevent the movement of the components within the case and to cushion the components from shock. The electronic components are mounted on the PCB 15, which is connected to the battery 13 and mounted within the case 1. The PCB 15 has a set of circuits including a microcontroller (not shown) and a Wi-Fi module (not shown) for communication by Wi-Fi. The case 1 also contains a global positioning system (GPS) and/or multipurpose antenna 5 which, in one embodiment, has access to the glass for receiving and/or transmitting a GPS or positional signal. The GPS allows determining the whereabouts of the wearer to provide directions within a facility like and airport, and allows tracking of the wearer connection to external sensors by the wireless ANT+ protocol, and/or a computer by USB, and the sensors are heart rate monitors and footpads. The device has a microphone 16 and speaker 17 to permit spoken communication to be recorded and transmitted. In an embodiment, the device has radio-frequency identification (RFID) circuit 18 to permit location tracking and communication with other nearby devices.

To communicate with other devices nearby or with a base station, the device may have a universal serial bus (USB) connector 19 to send/receive data and power for the battery 13, and may also have a contactless smart card chip (MIFARE ISO/IEC 14443-A) 20 for using near-field communications (NFC) to communicate with nearby devices, enabling an access-control system to track passengers and baggage access. There may also be a micro subscriber identity module (SIM) 22, which permits the device to be used and identified as a mobile phone, as well as providing memory for data storage in the device. The SIM 22 securely stores the service-subscriber key (IMSI) and is used to identify and authenticate the user of the smart secure access. The SIM 22 allows the user to change smart secure access by removing the SIM 22 from one device and inserting the SIM 22 into a second device. The SIM 22 allows the device to access a cellular radio system, so it can make and receive phone calls over a radio link while moving around a wide geographic area, and allows access to a public telephone network. Smart secure access also supports text messaging, MMS, email, internet access, infrared and Bluetooth through the SIM 22.

The device 25 also contains an alarm or alert system comprising an audible alert such as a sound from a speaker, and a visual alert such as a flashing light, or a non-visual emission such as infrared light, for surreptitious tracking of a device user. The device 25 may also have a wired connection such as USB 19 for data uploads/downloads from and to its volatile memory, and for charging the battery 13. The battery 13 may be charged inductively, through the case 1. The device may also have a panic button, as one of pushers 6 and 7, which immediately triggers the audible and/or visual alerts as well as communicating distress with the security system 24.

The communication means 32 communicates with the security system 24, as well as other devices (not shown) using Wi-Fi, Near Field Communications, and/or Bluetooth. Other wireless communications protocols may be used without deviating from the scope of the invention. When communicating with the security system, data from the non-volatile memory may be sent by request (pull) from the security system 24 as well as on an automatic basis (push) periodically or on the occurrence of an event. The device 25 may communicate with nearby devices (not shown) to i) ascertain the position of the device, ii) determine the identities of other device users in near proximity or traveling with the first device user.

The multifunction device 25 may have an organizer unit, which stores information such as the traveler's itinerary and flight information in the non-volatile memory on the PCB 15 or within SIM22 and calls the information up at appropriate times, when requested by the user for example, or to represent a probable set of behaviours of the device wearer to the intelligence agencies. The organizer unit may contain contact information such as addresses and phone numbers for the user's contacts, and is able to share these through the communication means 32 where appropriate.

A tracking system 30 such as a Global Positioning System or other location determination system is located within the device 25, and is in communication with the electronic circuitry on the PCB 15, to assist in situating the user, when looking for his or her gate for example. Additionally, the location determination may provide information to security personnel who are looking for a particular person, whether they are a terrorist threat or simply lost and in an unauthorized area. This information is also useful for determining the location of lost or kidnapped children.

Different access levels are available for the devices 25. The user would receive unclassified access; in that they may retrieve their own personal information however would not be able to retrieve information about other passengers. Unclassified access contains information about airport, airlines, hotels, resorts, and other service providers. Border services agencies would have access to information classified as confidential access, which includes present and historical location of user and content of communications, for example. Law Enforcement and Intelligence Community have access to yet higher classification of Secret access, containing information on actual communications made by the user, for example. Finally, the highest level of access, Top Secret access, is reserved for intelligence agencies. Access may be controlled in other ways as well, so airport authorities would have access to the users within the vicinity of the airport but not within another airport, for example, whereas operators of the security system would be able to see information for users within many airports and between airports, to see larger patterns in the information.

The multifunction device 25 is linked to a particular user, who is assigned a GIPI number based on Government-Issued Photo Identification (GIPI), and contains the user's personal data. The data may include, but is not limited to, carrier information, such as airline, flight and seat numbers, whether the user or baggage is suspicious, misplaced and time of last access, hotel information such as provider, hotel room number and length of stay, as well as special needs ranging from disabilities to meal requirements. Once the device 25 is associated with a particular user, it may be “locked” onto the wrist or other physical connection with a user, so that it may not be removed and exchanged with a different user without an authority's permission. The device 25 may be affixed to the user by a locking wristband known in the art, which cannot be removed without a special tool, for example, and that emits an alarm when removed, so as to alert the security system 24 as to the removal, and therefore insecurity, of that particular device 25. Once labelled insecure, a device 25 may not be used for access to airplanes, hotels or other paid services.

To organize the data associated with a particular user, the device 25 firmware or software further comprises a Smart Secure Access unit, a boarding access unit, a hotel access device and a baggage access device. The Smart Secure Access unit contains the itinerary data of the user with security information, so as to be able to verify the user is the authorized traveler without the need for further identification (passport, driver's license). Travelers may be authorized by customs of the destination country in advance, without the need to travel to the country first. The traveler's list may be cross-referenced in advance with a threat list held by the destination country, so as to prevent the entry of threats to the destination country. Similarly, refugees may be screened for their ability to successfully claim status, in advance of reaching the destination country.

The Smart Secure Access unit operates in conjunction with an eBoarding Pass, which replaces the traditional paper boarding pass currently in use. The eBoarding Pass can be downloaded to the device 25 once the trip payment is made or trip itinerary confirmed. With the eBoarding Pass, the passenger can proceed directly to security and does not need to check in again at the airport. A barcode image appears on the display 10 of the device 25 for scanning at the gate by an ISO standard handheld Smart Card and Barcode Reader under standard PDF417 ISO/IEC 15438. A GIPI is optional as the GIPI may be associated with the wearer of the device 25 and the device may be locked on to the wearer. If a seating upgrade is received, this happens electronically and there is no need to further retrieve a new boarding pass at the gate.

The boarding access unit communicates with the boarding control processes of the aircraft operators, so as to permit the user to enter the aircraft using the device 25 alone, without the need to produce further identification. This prevents the loss of boarding cards and reduces the inconvenience of carrying the boarding cards and identification through security. Further, the airlines may cross-reference the passengers name with a threat list or no-fly list. For example, if the user has recently traveled to a listed country, he or she may be prevented from boarding the flight.

The hotel access unit 36 permits the user to access the hotel without further identification or reservation information, which may easily become lost during travels. The user is pre-authorized for the hotel based on the authorizing device 2. Non-authorized users may be flagged and prevented from entering the hotel, or restricted to certain areas, based on communications with their devices (not shown). Further, the device may be used to track the user within the hotel and determine the areas of interest to that user.

The Smart Secure Access permits entry through ISO standard barrier gates where authorized, as well as ISO/IEC RFID electronic locks. The latter is particularly useful for hotel rooms and other areas that are locked and authorized to the particular user.

The baggage access device 38 may be used to verify that a user is the correct owner of a bag, in order to eliminate theft of baggage from the baggage arrival area such as the carrousel, for example. When the luggage arrives from the airplane, each piece is identified by a Radio Frequency Identification (RFID) tag to a particular user as identified by a device worn by the user. The baggage access device 38 is equipped with a contactless smart card chip and/or barcode for easy scanning and identification. Each baggage access device 38 has a unique serial number to enable electronic access control systems to track baggage access, prevent access from unauthorized persons. The baggage access device also has a passive or active (battery assisted) RFID tag for easy identification.

An authority, after verifying the personal data, will attach the device to the user and upload the personal data to the device. The multifunction device has an arm band that links around the arm, and sets off an alarm, either audible or silent, when removed. It may be durable and difficult to break, in the case of monitoring prisoners, for example. The alarm may be reported to the security personnel through the security system, such that the personnel are informed of a potential security threat removing his or her bracelet.

The security system 24 is a system external to the device which is operated by the authorities, and contains a database as well as a wireless communication capability, by which data may be communicated between the database and one or more devices.

Optionally, the multifunction device 25 may have a secure 1-way communication facility for messaging from the security system to individual users. Alternatively the device has a 2-way communication facility (walkie-talkie) for communication between users, or between users and the security personnel. Further, alarms or notices may be distributed to users by means of the 1-way or 2-way communication system. An alarm button or notifier (panic button) may also be present on the multifunction device 25, such that it may be pressed by a user who is in difficulties or at risk of harm. A signal is sent to the security system alerting the security personnel or authorities as to the difficulties and the location of the user. The alarm system may work together with the 2-way communication such that help can be provided remotely, in the manner of a 911 call, and the authorities are able to ascertain the type of assistance that is required and the level of urgency. The multifunctional device may optionally provide flashing light and/or audible warning to draw attention to the user in difficulty or at risk of harm. In an airport setting, the authorities may include Airport Police and Security, Airlines Security, Sky Marshal, Air Traffic Control, Hotel Authority and Hotel Security.

The device 25 may communicate wirelessly the identity of the user to authorities having authorized access levels, such that authorities may apprehend or question the user if necessary.

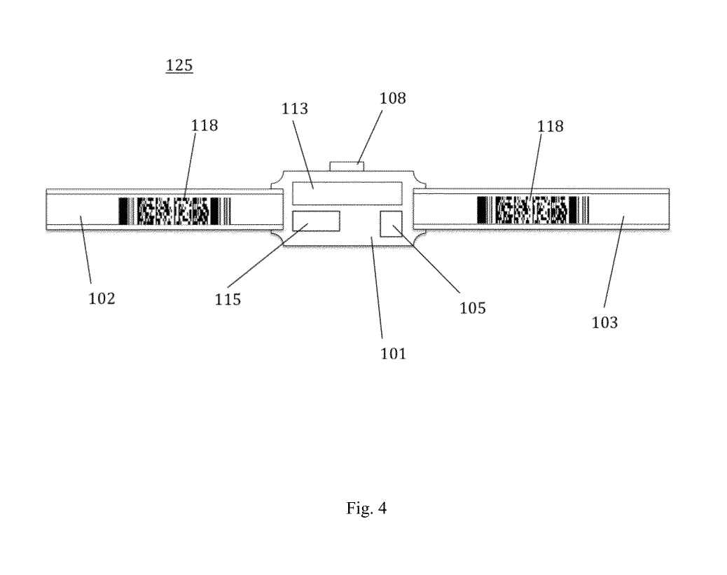

With reference to FIG. 4, a multifunction device 125 may also be used for tracking baggage. In such an embodiment a display 10 would not be required. The multifunction device would interface, using wireless means, with a handheld scanner used by security personnel to identify a baggage by means of a barcode 118 or other identifying means such as RFID (not shown) which uses an antenna 105.

A case 101 holds the electronic components of the multifunction device and protects them from the environment. The case 101 may be any shape that is practical for holding the components; however a square case is preferred. Baggage straps 102 and 103 extend from either side of the case, in a pivotal relation with the case, and are adapted for closing around the luggage. In one embodiment, pusher 8 is an on/off switch for the device to “awaken” and provide a signal.

To provide power, a battery 113 is contained within the case 101. Within the case there may be one or more supports (not shown) to prevent the movement of the components within the case and to cushion the components from shock. The electronic components are mounted on the PCB 115, which is connected to the battery 113 and mounted within the case 1. The PCB 115 has a set of circuits including a microcontroller (not shown) and a Wi-Fi module (not shown) for communication by Wi-Fi. The case 101 also has an antenna 5 for transmitting the RFID signal.

Use

The multifunction device is worn by all users passing through an airport or other access-restricted or sensitive facility. A user may then look at the device display and receive information as to the gate or timeliness of a flight, for example. The data on the multifunction device is constantly updated by the security system through wireless communication means so that the most current information is contained on the multifunction device.

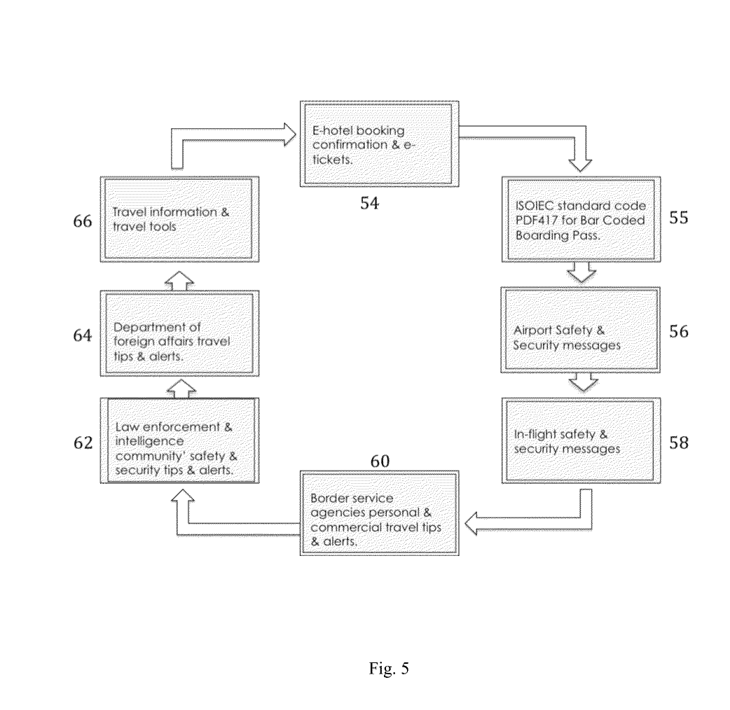

In FIG. 5, a method of use is shown. In step 54, the e-booking of the travel plans is made and e-tickets are downloaded to the smart secure access multifunction device 25. In step 55, an ISOIEC standard barcode is generated for the itinerary and stored within the device 25, for use at boarding gates, for example, instead of a paper boarding pass. Optionally, in step 56 the airport safety and security information email messages are downloaded to the device 25 for display to the user. Further, also optionally, in step 58 in-flight safety and security, and in-flight services description is downloaded to the device 25. In step 60, the border service agencies personal and commercial travel tips and alerts are downloaded to the device 25 for display to the user. In step 62 the law enforcement agencies travel tips and alerts are downloaded to the device for display to the user. In step 64 the department of foreign affairs' travel tips and alerts are downloaded to the device 25 for display to the user. In step 66 further travel information and tools are downloaded to the device 25 for display to the user.

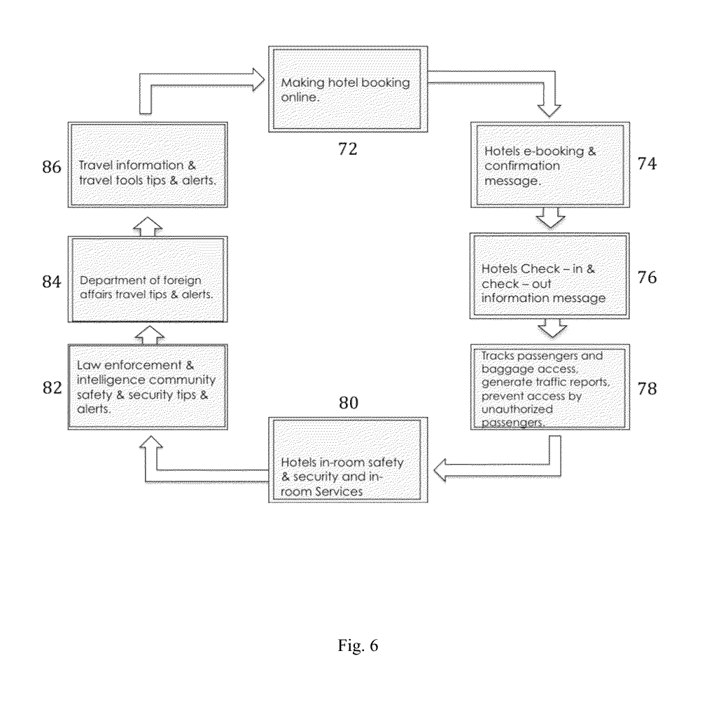

With reference to FIG. 6, a method of use for the device in regards to a hotel booking is shown. In step 72, the booking is made and the confirmation appears on the device 25. In step 74 the hotels e-booking confirmation is downloaded to the device 25 once the booking is made. In step 76 the check-in information is downloaded to the device 25 for display to the user. In step 78 the device 25 tracks passengers and baggage access, and optionally generates traffic reports and prevents access by unauthorized passengers on a person-by-person basis. In step 80, the hotel in-room safety and security messages are downloaded to the device 25 for display to the user. In step 82 the law enforcement agencies' tips and alerts are downloaded to the device 25 for display to the user. In step 84 the Department of Foreign Affairs tips and alerts are downloaded to the device 25 for display to the user. In step 86 further travel tips and tools are downloaded to the device 25 for display to the user.

What is claimed is:

1. A multifunction device for tracking passengers, comprising:
a. a case;
b. a battery within the case for powering the device;
c. a bodily attachment means mounted to the case for attaching the case to the body of a passenger;
d. a screen on the case for displaying information to the passenger;
e. a GPS receiver mounted within the case, for receiving position data; and
f. a wireless transmitter mounted within the case, for transmitting data wirelessly;
wherein the device tracks the location of the wearer through the GPS receiver and directs the passenger within a travel infrastructure through information on the screen, such that the passenger is able to efficiently move through the travel infrastructure.

2. The multifunction device of claim 1 wherein the device transmits the location of the passenger to a security system through the wireless transmitter.

3. The multifunction device of claim 1 wherein the wireless transmitter transmits authorization information to enable the passenger to access areas of the travel infrastructure.

4. The multifunction device of claim 1 wherein the wireless transmitter transmits authorization information to enable the passenger to receive luggage.

5. The multifunction device of claim 1 wherein the screen displays a barcode for a boarding pass for scanning by airline staff.

6. The multifunction device of claim 1 further comprising a SIM for communicating on a cell network.

7. The multifunction device of claim 1 wherein the device is locked to the passenger and the device is keyed to government-issued photo identification of the passenger.

8. The multifunction device of claim 1 wherein the wireless transmitter is in communication with nearby devices to determine the identities of other device users in near proximity with the passenger.

9. A multifunction device for tracking luggage, comprising:
a. a case;
b. a battery within the case for powering the device;
c. a luggage attachment means mounted to the case for attaching the case to the luggage; and
d. identification means.

10. The multifunction device of claim 9 wherein the identification means is selected from the group consisting of a barcode, an RFID signal and a wireless signal.

11. The multifunction device of claim 9 further comprising a wireless transmitter mounted within the case, for transmitting identify data of the luggage wirelessly.

12. The multifunction device of claim 9 further comprising a GPS receiver, wherein the multifunction device transmits location data of the luggage to a security system through the wireless transmitter.

13. A method of use for a multifunction device for tracking passengers, comprising the steps of:
a. e-booking of the travel arrangements;
b. downloading e-tickets to the multifunction device;
c. generating an ISOIEC standard barcode for the itinerary and storing the barcode within the device; and
d. displaying the barcode at a gate in order to board an airplane.

14. The method of claim 13 further comprising the step of displaying airport safety and security information on the device.

15. The method of claim 13 further comprising the step of displaying in-flight safety and security information on the device.

16. The method of claim 13 further comprising the step of displaying law enforcement agency safety and security information on the device.

17. The method of claim 13 further comprising the step of displaying government department of foreign affairs department safety and security information on the device.
